(19) United States
(12) Patent Application Publication
(10) Pub. No.: US 2009/0150181 A1
(43) Pub. Date: Jun. 11, 2009

(54) Method and system for personal medical data database merging

(75) Inventors: Igor Gejdos, Indianapolis, IN (US); Schuyler Buck, Muncie, IN (US); Christopher Richard Baker, Fishers, IN (US); Morris J. Young, Indianapolis, IN (US); Keith E. Bernard, Fort Wayne, IN (US); Stephen E. Moak, Fort Wayne, IN (US); Ryan Scott McKinney, Jamestown, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,772

(22) Filed: Dec. 7, 2007

(51) Int. Cl. G06Q 50/00

(52) U.S. Cl. 705/3; 705/2

(57) ABSTRACT

A method and system for merging databases containing medical, patient and/or healthcare, information is provided, which may be utilized to merge a source database containing medical information into a new or existing destination database. The method may include the steps of identifying a source database containing medical information, identifying a destination database for the receipt of the medical information from the source database, selecting rules for governing the migration of medical information into the destination database, and migrating the medical information from the source database to the destination database. In one exemplary embodiment, the medical information is a plurality of individual patient's medical records. In another exemplary embodiment, the medical information is a plurality of healthcare provider records.

### FIELD OF THE INVENTION

The present invention relates to a method and system for merging databases containing medical information.

### BACKGROUND OF THE INVENTION

Many fields of medical treatment and healthcare require monitoring of certain body functions. Thus, e.g., for patients suffering from diabetes, a regular check of the blood glucose level forms an essential part of the daily routine. The blood glucose level has to be determined quickly and reliably several times per day. Health monitoring devices are used to facilitate the collection of medical information without unduly disturbing the lifestyle of the patient. A large number of health monitoring devices for monitoring various body functions are commercially available.

Nevertheless, the use of health monitoring devices involves some risks which are mainly due to the complexity of using health monitoring devices. The risks are sometimes more pronounced for elderly patients or infants. Misuse of the health monitoring devices may lead to handling failures and to insufficient or even inaccurate information. Further, since many of the patients handling the health monitoring devices have not undergone medical training, the interpretation of the medical data collected by the health monitoring devices may be challenging to them. Often, patients are required to see their doctors in short time-intervals on a regular basis.

To reduce the frequency of necessary visits to doctors, the idea of home care gained popularity over the recent years. The availability of communication networks, such as the internet and wireless communication networks, led to the development of health management systems that enable transmission of patient medical data from the patient's home to a healthcare center by using health monitoring devices and data transfer systems. U.S. Pat. No. 7,103,578 and U.S. Published Application No. 2004/0172284 disclose two such methods and systems.

Known health management systems have several disadvantages. Some systems provide limited interaction capabilities to patients and care givers. Often, systems have limited analytical capabilities. Further, many health management systems do not permit collection of additional data or modification of data collected by the health management system. A need remains for systems that facilitate the use and interpretation of patient medical data.

### SUMMARY OF THE INVENTION

The present invention is a method and system for merging databases containing medical, e.g., patient and/or healthcare, information. For example, the present invention may be utilized to merge a source database containing medical information into a new or existing destination database. The present invention includes identifying a source database containing medical information, identifying a destination database for the receipt of the medical information from the source database, selecting rules for governing the migration of medical information into the destination database, and migrating the medical information from the source database to the destination database. In one exemplary embodiment, the medical information is a plurality of medical records for individual patients. In another exemplary embodiment, the medical information is a plurality of healthcare provider records.

In one exemplary embodiment, the present invention automatically identifies source databases of a type specified by the user or, alternatively, that appear to contain the type of medical information that corresponds to the destination database. For example, the present invention may be used in conjunction with or incorporated into medical management software. In one exemplary embodiment, the medical management software is disease management software, such as diabetes management software. In medical management software, it is important to ensure that specific, individual records containing medical information are properly associated with an individual patient and/or healthcare provider.

To prevent the entry of duplicative information, a system according to the present invention may further include that ability to identify whether medical information in the source database is substantially identical to medical information in the destination database. In one exemplary embodiment, the present invention compares medical information in the source database with medical information in the destination database to determine if an individual patient has medical information in both the source database and the destination database. If a patient has medical information in both the source database and the destination database, the present invention may merge into the destination database only the patient's individual records in the source database that contain medical information that is not already present in the destination database. Similarly, in another exemplary embodiment, a system according to the present invention may also compare healthcare provider information in the source database to healthcare provider information in the destination database and merge only the healthcare provider information not present in the destination database into the destination database.

Once a system according to the present invention has concluded the transfer of medical information from the source database to the destination database, the system may provide a migration summary report including, for example, the new patients or new healthcare providers created in the destination database during data migration that qualify as being unique, new patients or healthcare providers created in the destination database during the migration that were substantially identical to patients or healthcare providers already in the destination database, patients or healthcare providers having medical information that was merged into the medical information of a substantially identical patient or healthcare provider in the destination database, and/or patients or healthcare providers that were skipped, i.e., had medical information in the source database that was not in the destination database and that was not transferred to the destination database, during the migration.

By facilitating the migration of medical information in a source database to a destination database, a system according to the present invention allows for a healthcare provider or patient to upgrade to new medical management software or to new versions of the same and/or create new databases for use with the medical management software without the need to manually enter the medical information contained within the source database into the destination database. Further, by facilitating the identification of substantially identical medical information, such as individual patient and/or healthcare provider information, a system according to the present invention may substantially lessen the need to manually review the medical information for substantially identical entries.

### BRIEF DESCRIPTION OF THE DRAWINGS

The above-mentioned and other features of this invention, and the manner of attaining them, will become more apparent and the invention itself will be better understood by reference to the following description of an embodiment of the invention taken in conjunction with the accompanying drawings, wherein:

FIG. 1 is a schematic view of a health care management system;

FIG. 2 is a flowchart diagram view of a data migration process using the methodology of an exemplary embodiment of the present invention;

FIG. 3 is a screenshot of a source database type page according to an exemplary embodiment of the present invention;

FIG. 4 is a screenshot of a source database selection page according to an exemplary embodiment of the present invention;

FIG. 5 is a screenshot of a destination database selection page according to an exemplary embodiment of the present invention;

FIG. 6 is a screenshot of a check database warning page according to an exemplary embodiment of the present invention;

FIG. 7 is a screenshot of an options guide page according to an exemplary embodiment of the present invention;

FIG. 8 is a screenshot of a patient options page according to an exemplary embodiment of the present invention;

FIG. 9 is a screenshot of a physician options page according to an exemplary embodiment of the present invention;

FIG. 10 is a screenshot of a data migration process page according to an exemplary embodiment of the present invention;

FIG. 11 is a screenshot of a duplicate patient identification dialog according to an exemplary embodiment of the present invention;

FIG. 12 is a screenshot of a new medical management system identification prompt according to an exemplary embodiment of the present invention;

FIG. 13 is a screenshot of a duplicate healthcare provider dialog according to an exemplary embodiment of the present invention; and

FIG. 14 is a screenshot of a data migration complete page according to an exemplary embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects,” each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Both programs and databases may be objects. In the case of databases, the data portion of the object may be significantly larger than the methods portion, The actual physical implementation of a database on a general purpose computer may take several forms, from complete individual records storing the substantive information with several key indexes for locating a particular record, to a plurality of tables interrelated by relational operations, to a matrix of cross-linked data records, to various combinations and hybrids of these general types. In particular physical devices, a database may be structured and arranged to accommodate the restrictions of the physical device—but when transferred to a general purpose computer be able to be stored in a variety of formats. Thus, while certain types of information may be described as being stored in a “database” from a conceptual standpoint, generally such information may be electronically stored in a variety of structures with a variety of encoding techniques.

Databases may contain many types of information, and may store the information in a variety of encoding techniques. When a database stores information that relates to a particular person, product, location, or other thing, the database typically uses a unique identifier that binds the “concept” of the person, product, location, or other thing with a storable piece of data. When the unique identifier is used to reference the data record, the unique identifier is termed a “key” and data records associated with the “concept” are said to be “keyed” by the unique identifier. The association between a key and its data may be implemented in a variety of ways, for example by having the key be a field in a corresponding data record, by having a key value in a search tree with an associated pointer to one or more data records corresponding to the key, or by encoding the corresponding information with a value that upon decoding produces the unique identifier and the corresponding data, etc. By these various methods, instances of data may be associated with, or “bound” with or to, the “concept” by using the key.

The terms “network,” “local area network,” “LAN,” “wide area network,” or “WAN” mean two or more computers which are connected in such a manner that messages may be transmitted between the computers. In such computer networks, typically one or more computers operate as a “server,” a computer with large storage devices such as hard disk drives and communication hardware to operate peripheral devices such as printers or modems. Other computers, termed “workstations,” provide a user interface so that users of computer networks can access the network resources, such as shared data files, common peripheral devices, and inter-workstation communication. The computers have at least one processor for executing machine instructions, and memory for storing instructions and other information. Many combinations of processing circuitry and information storing equipment are known by those of ordinary skill in these arts. A processor may be a microprocessor, a digital signal processor (“DSP”), a central processing unit (“CPU”), or other circuit or equivalent capable of interpreting instructions or performing logical actions on information. Memory includes both volatile and non-volatile memory, including temporary and cache, in electronic, magnetic, optical, printed, or other format used to store information. Users activate computer programs or network resources to create “processes” which include both the general operation of the computer program along with specific operating characteristics determined by input variables and its environment.

Concepts described below may be further explained in one of more of the co-filed patent applications entitled HELP UTILITY FUNCTIONALITY AND ARCHITECTURE (Atty Docket: ROCHE-P0033), METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), EXPORT FILE WITH MANIFEST FOR ENHANCED DATA TRANSFER (Atty Docket: ROCHE-P0044), GRAPHIC ZOOM FUNCTIONALITY FOR A CUSTOM REPORT (Atty Docket: ROCHE-P0048), METHOD AND SYSTEM FOR SELECTIVE MERGING OF PATIENT DATA (Atty Docket: ROCHE-P0065), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0044), COMMON EXTENSIBLE DATA EXCHANGE FORMAT (Atty Docket: ROCHE-P0036), METHOD OF CLONING SERVER INSTALLATION TO A NETWORK CLIENT (Atty Docket: ROCHE-P0035), METHOD AND SYSTEM FOR QUERYING A DATABASE (Atty Docket: ROCHE-P0049), METHOD AND SYSTEM FOR EVENT BASED DATA COMPARISON (Atty Docket: ROCHE-P0050), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING REPORTS (Atty Docket: ROCHE-P0046), METHOD AND SYSTEM FOR CREATING USER-DEFINED OUTPUTS (Atty Docket: ROCHE-P0047), DATA DRIVEN COMMUNICATION PROTOCOL GRAMMAR (Atty Docket: ROCHE-P0055), HEALTHCARE MANAGEMENT SYSTEM HAVING IMPROVED PRINTING OF DISPLAY SCREEN INFORMATION (Atty Docket: ROCHE-P0031), and METHOD AND SYSTEM FOR MULTI-DEVICE COMMUNICATION (Atty Docket: ROCHE-P0064), the entire disclosures of which are hereby expressly incorporated herein by reference. It should be understood that the concepts described below may relate to diabetes management software systems for tracking and analyzing health data, such as, for example, the ACCU-CHEK® 360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the ACCU-CHEK® Active, ACCU-CHEK® Aviva, ACCU-CHEK® Compact, ACCU-CHEK® Compact Plus, ACCU-CHEK® Integra, ACCU-CHEK® Go, ACCU-CHEK® Performa, ACCU-CHEK® Spirit, ACCU-CHEK® D-Tron Plus, and ACCU-CHEK® Voicemate Plus, all provided by Roche Diagnostics or divisions thereof.

The present invention is a method and system for merging databases containing medical, e.g., patient and/or healthcare, information. For example, the present invention may be utilized to merge a source database containing medical information stored in a source format into a new or existing destination database stored in a destination format. In one exemplary embodiment, the source database may be saved on a hard disk located at a first physician's office and the destination database may be saved on a hard disk located at a second physician's office. In another exemplary embodiment, the source database may be saved at a first location on a hard disk and the destination database may be saved at a second location on the same hard disk. Additionally, in one exemplary embodiment, the medical information stored the source and destination databases includes diabetes testing and/or treatment information for an individual patient. While the invention is described herein with reference to medical management software, and more particularly, with reference to diabetes management software, the invention may be applied, generally, to data management systems in fields unrelated to healthcare management

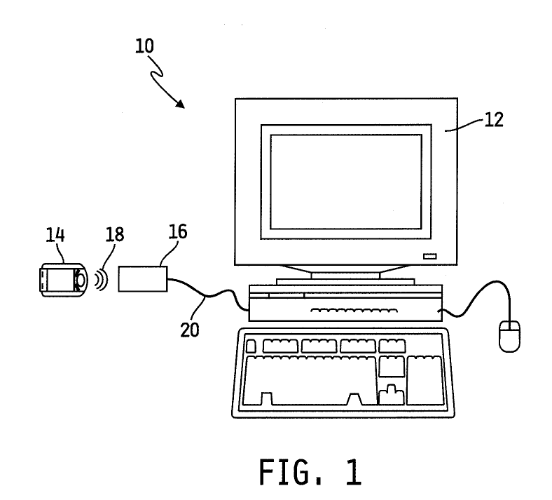

Referring to system 10, shown in FIG. 1, a patient may utilize portable medical device 14, which in one exemplary embodiment is a blood glucose monitor, to monitor and/or test various medical conditions, such as blood glucose levels. Although blood glucose values are discussed herein, it should be understood that medical device 14 may be of a type for collecting other information such as A1c values, Albumin values, Albumin excretion values, body mass index values, blood pressure values, carbohydrate values, cholesterol values (total, HDL, LDL, ratio) creatinine values, fructosamine values, HbA1 values, height values, insulin dose values, insulin rate values, total daily insulin values, keytone values, microalbumin values, proteinuria values, heart rate values, temperature values, triglyceride values, and weight values. The information stored in portable medical device 14 may then be transferred to data collection device 16. While the invention is described herein with reference to medical devices, and more particularly, with reference to diabetes management devices, the invention is applicable to any data obtained from any device.

In one exemplary embodiment, the information is transferred from portable medical device 14 to data collection device 16 through infrared signal 18. Once the information is received by data collection device 16, it is transferred to computer 12 via communication cable 20. While described and depicted herein with specific reference to a computer, the present invention may be utilized in conjunction with any device capable of running medical management software, such as an infusion pump, a blood glucose meter, or an integrated device including a glucose measurement engine, a PDA, or a cell phone.

In another exemplary embodiment, portable medical device 14 may include a port for direct connection to communication cable 20. Computer 12 may be running medical management software, such as diabetes management software, and encrypt and save the medical information transferred from portable medical device 14 in one of a source format database or a destination format database. The information received from portable medical device 14 is encrypted according to an encryption feature that is specific to portable medical device 14. Thus, if another portable medical device is used to upload information to computer 12, it is encrypted according to a different specific encryption feature of that device. Portable medical device 14 may also assign to the patient an external system identification that may be used to correlate the patient to a particular portable medical device. Once the medical information is saved to computer 12 or other storage media connected thereto, a system according to the present invention may be used to merge the database containing the uploaded medical information with another database.

In one exemplary embodiment, the system of the present invention includes a data migration utility in the form of a machine-readable program that is adapted to be utilized independent of or as an integral component of medical management software, such as diabetes management software. For example, the data migration utility may be an object within the medical management software or, alternatively, may be stand alone software capable of independent operation and installation. In one exemplary embodiment, the data migration utility may be activated from the medical management software after the medical management software has been launched. In one exemplary embodiment, the medical management software is adapted to manipulate medical information stored in a destination database in the destination format.

In order to prevent unauthorized merging of data or access to confidential medical information, the data migration utility may be configured to allow only a single instance of the data migration utility to be operated for each user logged in at any given time. Thus, if a user attempts to launch a second instance of the data migration utility, the utility would prevent the launch. Further, the data migration utility may also verify that the login information of the user matches the login information for a corresponding medical management software user. In the event the login information does not match, the data migration utility does not launch or, if previously launched, shuts down. Further, if authorization to launch or access the data migration utility is not provided for the logged in user, an error message may be displayed indicating the user cannot operate the data migration utility and/or does not have authorization to access the same.

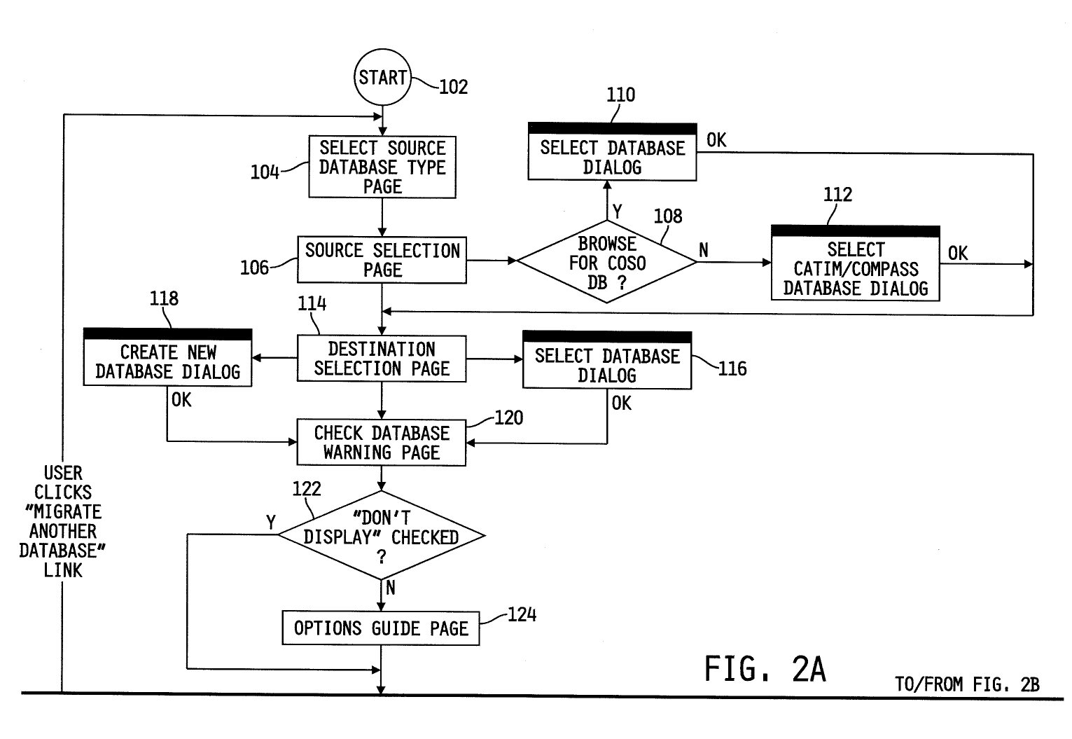

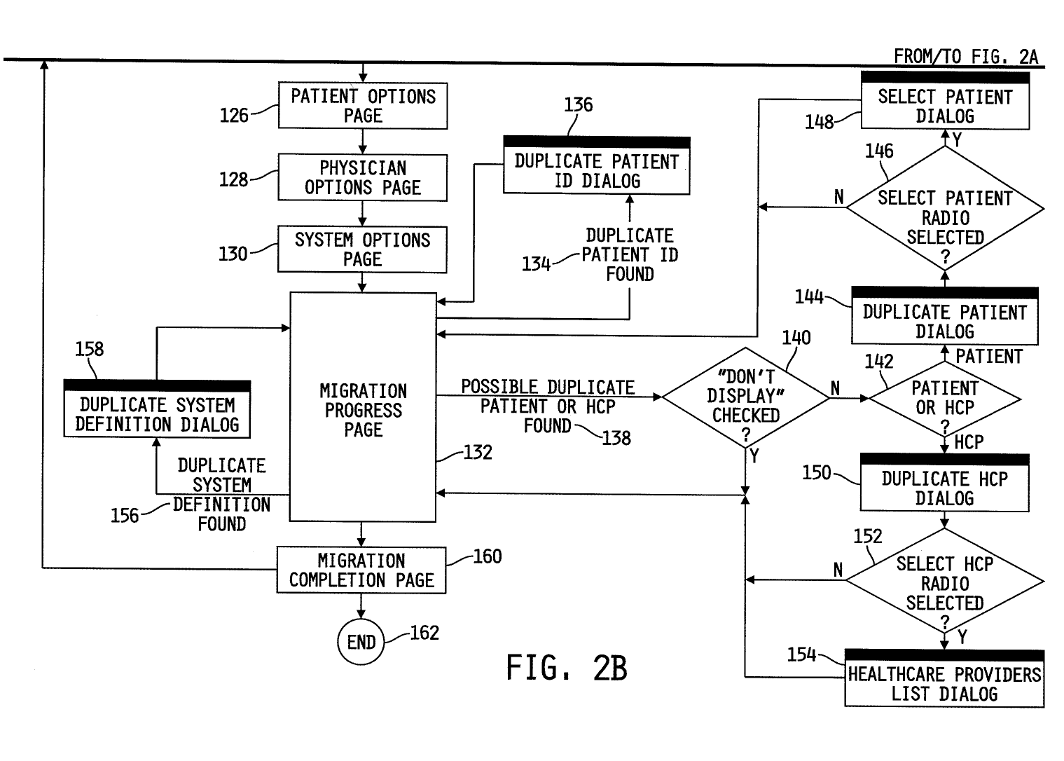

If a user passes the security checks contained within the data migration utility, the data migration utility is launched, as indicated on flowchart 100 of FIG. 2 at Start 102. In one exemplary embodiment of the invention, once the data migration utility is launched the user may be prompted for information by dynamic questionnaires in a wizard format. For example, the user may be prompted to set the rules governing the migration of data. Referring to Step 104, the user may be prompted to select a source database stored in a source format for migration into a destination database stored in destination format at the source database type page shown in FIG. 3. The source database type page allows the user to select a database type from a list of various database types meeting the necessary requirements for migration into the destination database. For example, the database types listed may include only those databases that will be compatible with the medical management software once merged into a destination database and converted from source format into destination format.

In one exemplary embodiment, the medical management software involves diabetes management software. Referring to FIG. 3, a list of databases that are compatible with the diabetes management software once merged into a destination database is provided. Specifically, as shown in FIG. 3, the source databases include, but are not limited to, databases associated with a glucose monitoring device or glucose monitoring software, such as those associated with ACCU-CHEK® Camit Pro, ACCU-CHEK® Compass, and ACCU-CHEK® 360°. Other source databases may alternatively be used in a system according to the present invention.

As shown in FIG. 3, positioned adjacent to each source database type displayed on the source database type page is a corresponding button. In one exemplary embodiment, only a single button may be selected at any given time. However, in other exemplary embodiments, multiple buttons may be selected for multiple, simultaneous database migration. By selecting the button corresponding to the desired source database type, a next or finish button may appear on the source database type page. By selecting the next or finish button, data merge processing may initiate and the user may progress to the next questionnaire in the data migration utility.

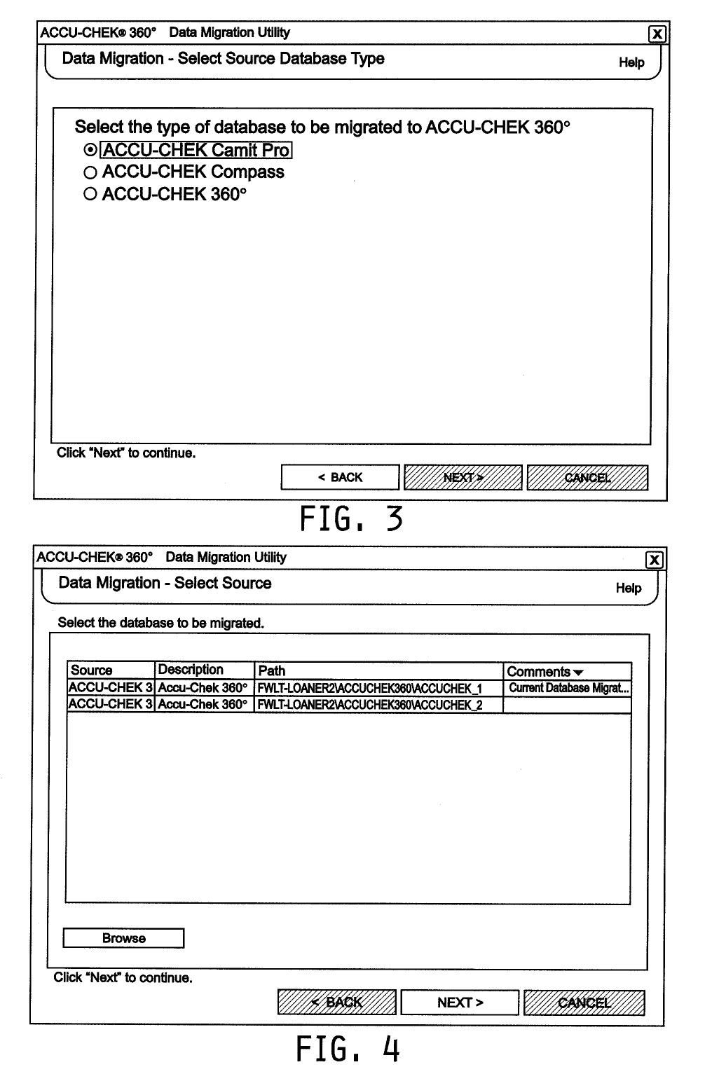

Once a source database type is selected and the user has also selected the next or finish button, the data migration utility displays a source database selection page at Step 106 in FIG. 2. Referring to FIG. 4, an exemplary source database selection page is shown that provides a listing of potential source databases by type and that may include general descriptions of the database, the file path for the database, and any comments relevant to the particular database. The source databases may be databases that contain medical information stored in a source format. For example, potential source databases may contain patient medical information that may further include numerous records associated with the individual patient having data fields for patient identity, including title, first name, middle name, last name, suffix, and date of birth, day and week information for the administration of medicine and/or for test results, such as blocks of time and days of week, targeted event information, contact information, such as address, phone number, and email address, emergency contact information, such as name, relation, address, and phone number, demographic information, such as diabetes diet, the diagnosis date, gender, and ethnicity, and diabetes therapy, such as controlled by and date and insulin type information, system identification, i.e., the patient's unique medical management system identification, insurance, and healthcare provider data. Similarly, the databases may include healthcare provider information that may further include numerous records associated with healthcare providers having data fields such as healthcare provider title, first name, middle name, and last name, suffix, specialty, practice area, and contact information, such as address, phone number and email address, for example.

The source database selection page may also include a browse button, shown in FIG. 4, which allows a user to manually search the computer's hard drive or other attached media devices for a database location that is not listed on the source database selection page. Referring to Step 108 in FIG. 2, if the user selects the browse function at the source database selection page by selecting the browse button, Step 110 is executed and the user is prompted to select a file path for the source database. In contrast, if the user does not select the browse feature at Step 108, the user must then select one of the databases identified on the source selection page in step 106.

Irrespective of the method utilized to select the source database, once the source database is selected the data migration utility may then display a destination database selection page at Step 114. The destination database selection page may provide a listing of the potential destination databases stored in a destination format. In one exemplary embodiment, the potential destination databases are databases that are currently used by the medical management software. In one exemplary embodiment, the destination selection page may include a listing of the type of database, a description of each database, the file path for each database, and any comment related to each database. Additionally, the destination database may contain medical information, such as patient medical and/or healthcare provider information, and may include fields identical to or substantially identical to those set forth above with respect to the source database.

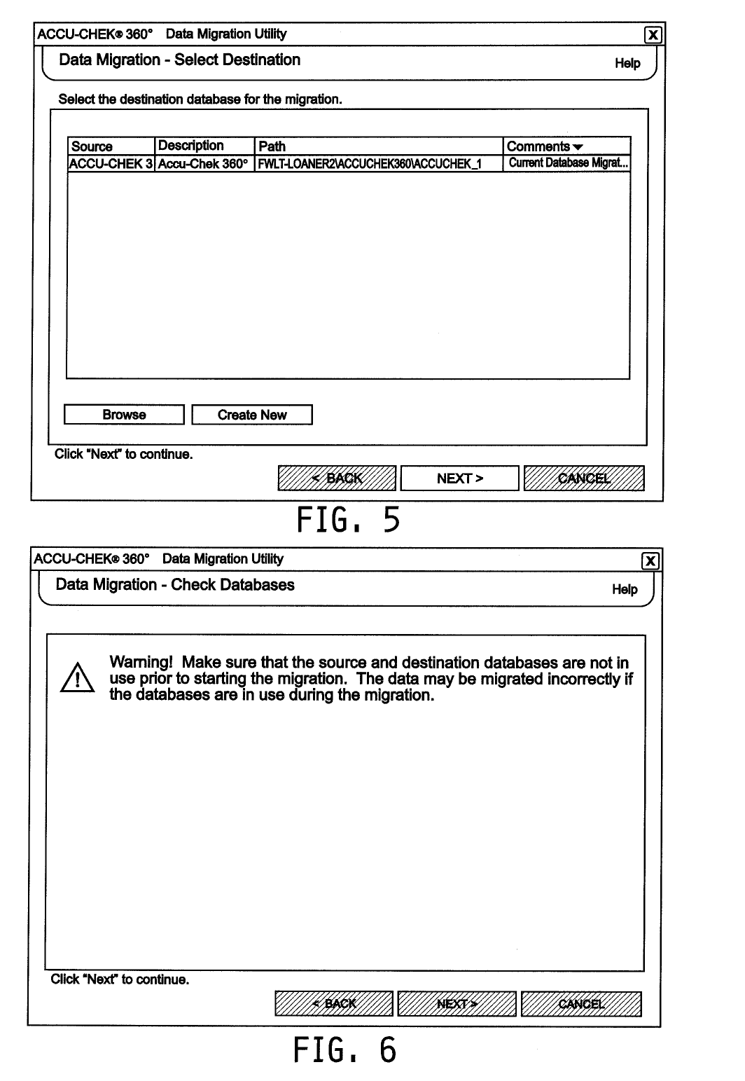

Referring to FIG. 5, which depicts an exemplary destination database selection page, the destination database selection page may include a browse button and/or create new button. If the browse button is selected, the user is directed to select a destination database in the same manner as in step 110 for selecting the source database. If the browse function is not selected, the user may either select one of the databases set forth on the destination database selection page by the data migration utility at Step 116 or, alternatively, the user may select the create new button. If the create new button is selected, a create new destination database dialog is activated at Step 118 and a new destination database is created. In one exemplary embodiment, the data migration utility further prompts the user to determine the file path where the new destination database is to be created. Additionally, the data migration utility may automatically assign the new destination database a file path that is associated with the corresponding medical management software.

Irrespective of the method utilized to select the destination database or whether a new destination database is created, a check database warning page is displayed at Step 120. An exemplary check database warning page is depicted in FIG. 6 and may include a warning that indicates to the user that any conflicting use of the source and destination databases during data migration will result in a migration error. In one exemplary embodiment, while the check database warning page is displayed, the data migration utility verifies that the source and destination database versions are correct and that the data contained therein is not corrupt. In another exemplary embodiment, the check database warning page opened at Step 120 in FIG. 2 may further include a next or finish button that requires an affirmative action by the user before the data migration utility may initiate the migration of data from the source database to the destination database and, if necessary, conversion of the same from the source format to the destination format.

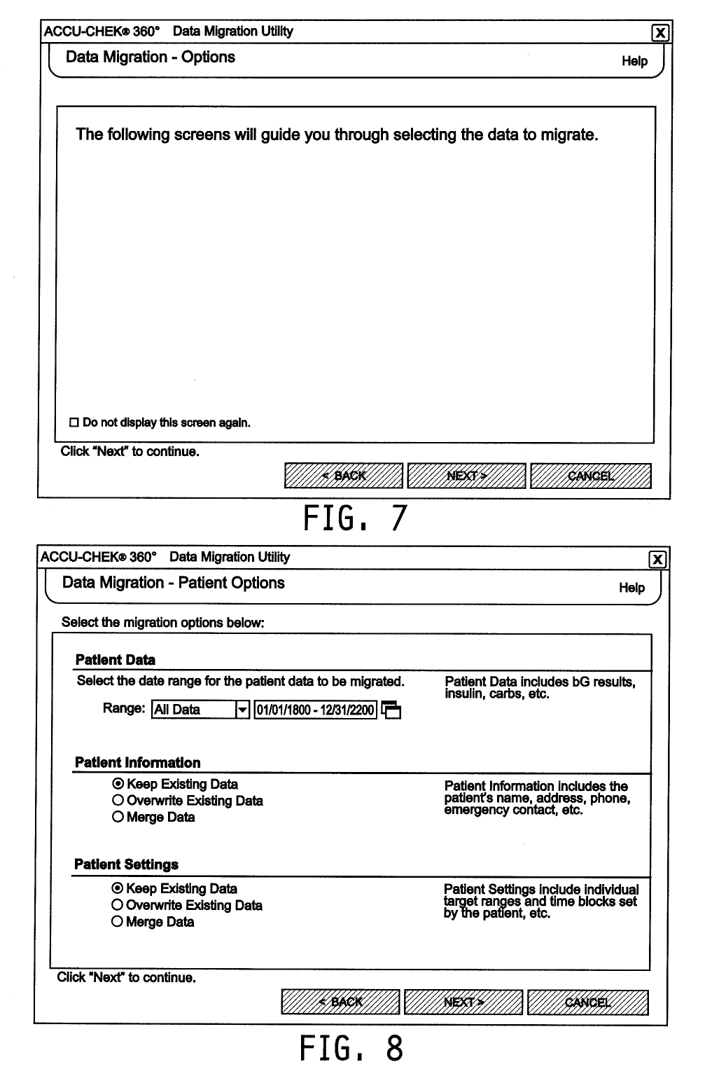

Once the next or finish button is selected, the data migration utility may open, at Step 124 in FIG. 2, an options guide page, shown in FIG. 7, to begin the options selection process. The options guide page may include a brief overview of the options guide page process and may also include a “don't display this page again” option with a corresponding button. If the button has previously been selected, then the data migration utility skips opening the options guide page at Step 124. However, if the “don't display this page again” feature has not been previously selected, the options guide page is displayed at Step 124.

After displaying the options guide page, a patient options page is opened at Step 126 in FIG. 2 that allows the user to select the specific patient related options to be applied during data migration. For example, in one exemplary embodiment, shown in FIG. 8, the patient options page allows for the selection of the date ranges of individual patient records to be migrated into the patient's corresponding file in the destination database. The patient options page may further allow the user to select how individual patient information is migrated into the destination database. For example, the patient options page may provide buttons to allow the user to select whether patient information from the destination database should be kept, whether patient information from the source database should override patient information in the destination database, or whether patient information in the source database should be merged with patient information in the destination database. Further, the user may also be provided with the option to determine whether individual patient settings should be kept where such settings in the destination database may apply to features in the corresponding medical management software, or alternatively should be overridden by the individual patient options set in the source database, or alternatively should be merged with the individual patient options from the source database.

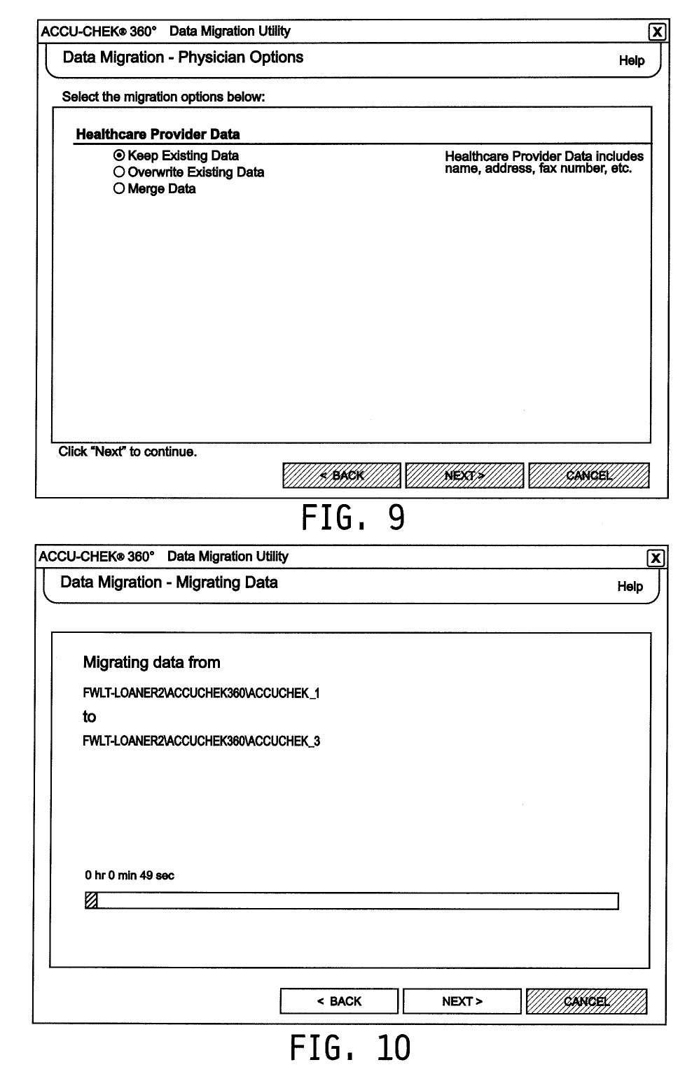

Once the user selects the desired patient options at the patient options page, a next button may be provided that the user may select, which results in the opening of a physician options page at Step 128. Referring to FIG. 9, the physician options page may provide a series of buttons for determining whether physician information from the destination database should be kept, whether physician information from the source database should override information in the destination database, or whether physician information in the source database should be merged with the physician information in the destination database. Additionally, in one exemplary embodiment, the user is provided with additional options for determining how physician information is handled during data migration.

Once the user selects the desired physician options at the physician options page, a next button may be provided that the user may select, which results in the opening of a systems options page at Step 130 in FIG. 2. The systems option page allows the user to select various system options, such as options that relate to the medical management software, that should be applied during data migration. Once the system options are set at Step 130, a next or finish button may be provided which the user may select to close the systems option page and end the options selection process. While the options selection process has been described and depicted herein as a specific series of screens and options, it is contemplated that any of the options and/or screens described herein may be removed and/or additional screens and/or options may be added to accommodate different approaches to workflow or for other reasons.

Once the options selection process is completed, the data migration process page, shown in FIG. 10, opens and data migration begins at Step 132 in FIG. 2. The data migration process page may show the identity of the source database by the file path and/or by the filename associated with the source database, or alternatively by a user or system defined name. Similarly, the data migration process page may also show the identity of the destination database by the file path and/or by the filename associated with the destination database. Additionally, the data migration process page may further provide a status bar that depicts in a graphical format the total amount of data to be migrated as compared to the total amount of data that has been migrated. Further, the data migration process page may provide the total amount of time that the data migration utility estimates the data migration to take and/or the amount of time the data migration utility estimates is remaining until data migration is complete.

Once migration is initiated at Step 132, the data migration utility begins importing records from the source database and creating corresponding records in the destination database in accordance with the options selected by the user during the options selection process, as set forth in detail above. Specifically, as set forth above, each record may be encrypted according to an encryption method specific to the individual portable medical device from which the information was originally uploaded. Thus, the data migration utility may decrypt the medical information associated with a first portable medical device that corresponds to an individual patient in the source database and then substantially simultaneously migrate and encrypt the same information into the destination database using the destination database encryption method. This process may then be repeated for subsequent portable medical devices corresponding to the same patient or different patients.

Alternatively, the data migration utility may be configured to decrypt medical information contained in the destination database, if any exists, and add it to a temporary database created by the data migration utility. The data migration utility may also decrypt the medical information contained in the source database and merge it into the medical information migrated into the temporary database from the destination database. Once all the medical information from the source database and the destination database has been merged into the temporary database, the information is re-encrypted using the destination database encryption method and saved in the destination database.

Additionally, during data migration, the data migration utility identifies specific medical information, such as medical information corresponding to an individual patient or healthcare provider, and searches the destination database to determine if identical or substantially identical medical information exists in the destination database. The specific manner and rules used by the data migration utility to determine whether medical information, such as an individual patient and/or health care provider, in the source database is identical or substantially identical to medical information in the destination database is set forth in a corresponding U.S. patent application, entitled METHOD AND SYSTEM FOR SELECTIVE MERGING OF PATIENT DATA, which is identified above.

Referring to Step 138 of FIG. 2, if a duplicative, i.e., identical, patient or healthcare provider is identified, the data migration utility pauses migration and determines at Step 140 if the user has previously indicated that all duplicate patients or healthcare providers should be added as new patients or healthcare providers in the destination database. If the answer is yes, migration resumes and a new patient or healthcare provider is created in the destination database. If the answer is no, the data migration utility determines at Step 142 if the potentially duplicate information corresponds to a patient or a healthcare provider.

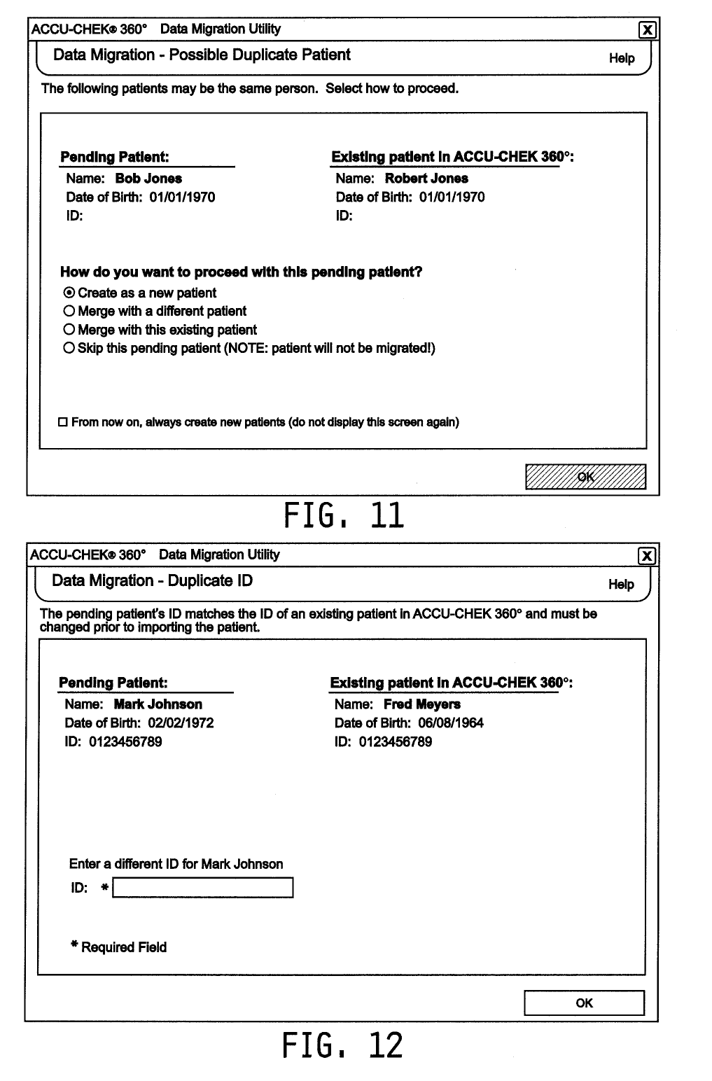

If the information corresponds to a patient, a duplicate patient dialog is opened at Step 144. Referring to FIG. 11, the duplicate patient identification dialog may provide information about the pending patient, i.e., the patient in the source database, such as name, date of birth, and the patient's unique medical management system identification. Similarly, the duplicate patient identification dialog may also provide information about the existing patient, i.e., the patient in the destination database, such as name, date of birth, and the patient's unique medical management system identification. The duplicate patient information dialog may then prompt the user to select the manner in which the record in the source database should be treated. For example, the user may select from adding the pending patient as a new patient in the destination database, selecting another patient from the destination database to merge the pending patient's information with, merging the pending patient with the existing patient, or skipping the pending patient, i.e., leaving the pending patient's information in the source database and not adding the same to the destination database.

Once the user has made the desired selection, the user may select an authorization button, such as the OK button in FIG. 11. Once the authorization button is selected, data migration is resumed. However, if at Step 144, the user indicates that another existing patient in the destination database should be merged with the patient in the source database, then, at Step 148, a select patient dialog is opened that allows the user to select a patient from the destination database into which the pending patient data from the source database is merged.

In one exemplary embodiment, the duplicate patient identification dialog may also include a button that allows the user to avoid the duplicate patient identification dialog for each duplicate patient identified. By selecting this option, each duplicate patient identified by the data migration utility is added as a new patient in the destination database. However, in the event that a pending patient in the source database that is to be added as a new patient in the destination database is determined, at Step 134 in FIG. 2, to have the same medical management system identification as an existing patient in the destination database, a duplicate identification dialog is opened at Step 136 and data migration paused. As shown in FIG. 12, the duplicate identification dialog prompts the user to enter a new medical management system identification for the pending patient before the patient will be added as a new patient in the destination database. Once a new patient identification is entered and an authorization provided by the user, such as by selecting the OK button in FIG. 12, data migration resumes and the pending patient in the source database is added as a new patient in the destination database.

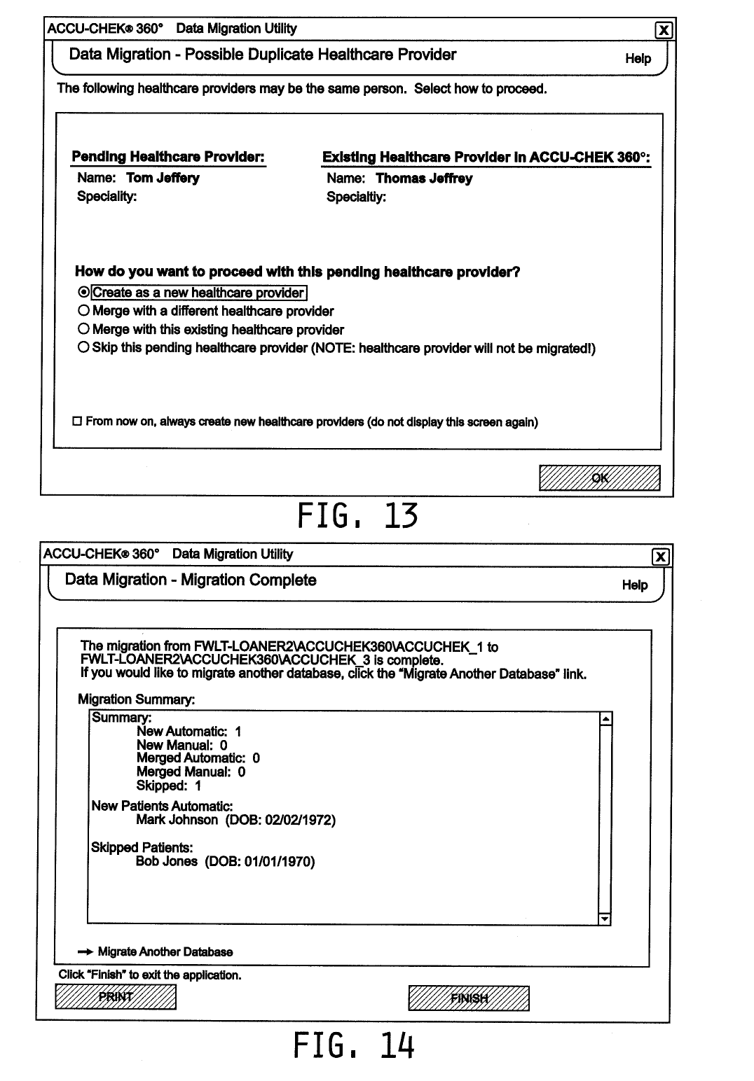

Alternatively, if the medical information is determined by the data migration utility to correspond to a healthcare provider at Step 142, then a duplicate healthcare provider dialog is opened at Step 150 and data migration paused. Referring to FIG. 13, the duplicate healthcare provider dialog may provide information about the pending healthcare provider, i.e., the healthcare provider in the source database. Similarly, the duplicate healthcare provider dialog may also provide information about the existing healthcare provider, i.e., the healthcare provider in the destination database. The duplicate healthcare provider dialog may then prompt the user to select the manner in which the healthcare provider information in the source database should be treated. For example, the user may select from adding the pending healthcare provider as a new healthcare provider in the destination database, selecting another healthcare provider from the destination database to merge the pending healthcare provider's information with, merging the pending healthcare provider with the existing healthcare provider, or skipping the pending healthcare provider, i.e., leaving the pending healthcare provider's information in the source database and not adding the same to the destination database.

Once the user has made the desired selection, the user may authorize the action, such as by selecting the OK button in FIG. 13. Once user authorization is provided, data migration resumes in accordance with the user's previous selections. However, if the data migration utility determines at Step 152 in FIG. 2 that the user has indicated that another existing healthcare provider should be selected for merging with the pending healthcare provider, a select healthcare provider dialog is opened at Step 154 and the user is allowed to select a different existing healthcare provider from the destination database into which the pending healthcare provider information from the source database is merged.

Additionally, in one exemplary embodiment, the duplicate healthcare provider dialog may also include a button that allows the user to avoid the duplicate healthcare provider dialog for each duplicate healthcare provider identified. By selecting this option, each duplicate healthcare provider identified by the data migration utility is added as a new healthcare provider in the destination database.

Further, if at any time during the migration of medical information, the data migration utility identifies a duplicate system definition, such as at Step 156, a duplicate system definition dialog is opened at Step 158 and data migration paused. The duplicate system definition dialog requires that the system definition in the source database be renamed before it can be migrated into the destination database. Once a new name is provided, the user may select an OK button in the duplicate system definition dialog to reinitiate data migration. While this is one exemplary method of creating a duplicate data instance and other possible identification in other database fields may be used where appropriate.

Once the migration from the source database to the destination database of all data selected for migration is completed, the data migration utility opens the migration complete page at Step 160. As shown in FIG. 14, the migration complete page may include a listing of the medical information transferred that is separated into categories by patient and healthcare provider. Additionally, the patient category may be further separated by new patients, merged patients, and skipped patients. In one exemplary embodiment, the migration complete dialog also indicates the number of new patients created and/or patients merged automatically and manually. The migration complete page may also provided a detailed listing of patient names for each category, as well as some basic patient information, such as name, date of birth, and the patient's unique identification number. Additionally, in one exemplary embodiment, the data migration complete dialog provides similar information for each healthcare provider identified during the migration.

In order to migrate another database, the user may select the migrate another database option provided by the data migration complete dialog. If the migrate another database option is selected, the migration process is restarted, beginning at Step 104 in FIG. 2. Alternatively, the data migration complete dialog may also include a close or finish button that may be selected by the user to close the data migration utility and end at End 162. Further, if at any time during operation of the data migration utility a user attempts to close the data migration utility, its closure results in that any information transferred to the destination database is not saved, and the source database is restored.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A device for providing access to medical information, comprising:
a source database having a plurality of medical records maintained in a source format, said source format including patient data;
a destination database configured for the receipt of medical records in a destination format; and
a data migration utility adapted to add the medical records from the source database to the destination database by converting the medical records from the source format to the destination format so that at least a portion of the patient data is incorporated into said destination database.

2. The device of claim 1, wherein said source database further comprises means for obtaining patient data from a portable device.

3. The device of claim 2, wherein said source format further comprises the patient data from the portable device.

4. The device of claim 1, wherein said destination database comprises a plurality of individual patient records.

5. The device of claim 4, wherein the plurality of individual patient records include fields for at least one of the following types of information: patient identity, day and week information for the administration of at least one of medicine and test results, demographic information, diabetes therapy, and healthcare provider data.

6. The device of claim 1, wherein said destination database comprises a plurality of healthcare provider records.

7. The device of claim 6, wherein the plurality of healthcare provider records include fields for at least one of the following types of information: name, specialty, practice area, and contact information.

8. The device of claim 1, wherein the data migration utility further comprises at least one of a duplicate patient information dialog and a duplicate healthcare provider dialog.

9. The device of claim 1, further comprising medical management software, the medical management software configured to read information in the destination format.

10. The device of claim 9, wherein the destination database is adapted to associate a patient with a plurality of records having patient data from a portable device.

11. The device of claim 9, wherein the medical management software comprises diabetes management software.

12. In a device, a method of merging databases, the method comprising the steps of:
obtaining patient data from a medical device and configuring the patient data in a source database having a source format;
selecting a destination database associated with medical management software that is adapted to manipulate medical information stored in a destination format;
migrating the medical information in the source database into the destination database by converting the medical information from the source format to the destination format so that at least a portion of the patient data from the medical device is incorporated into said destination database.

13. The method of claim 12, wherein the step of selecting a destination database includes selecting a destination database having a plurality of individual patient medical records.

14. The method of claim 12, farther comprising the step of selecting a method for migrating the medical information.

15. The method of claim 14, wherein the step of selecting a method of migrating the medical information comprises selecting one of: keeping existing data in the destination database, overwriting the existing data in the destination database, and merging the data from the source database into the destination database.

16. The method of claim 12, further comprising the step of identifying medical information in the source database that is substantially identical to medical information in the destination database.

17. The method of claim 16, further comprising the step of prompting a user to select a method of migrating the substantially identical medical information.

18. A machine-readable data migration utility on media storing instructions for a method of merging databases, the method comprising the steps of:
obtaining patient data from a medical device and configuring the patient data in a source database having a source format;
selecting a destination database associated with medical management software that is adapted to manipulate medical information stored in a destination format;
migrating the medical information in the source database into the destination database by converting the medical information from the source format to the destination format so that at least a portion of the patient data from the medical device is incorporated into said destination database.

19. The machine-readable data migration utility of claim 18, wherein the step of selecting a destination database includes selecting a destination database having a plurality of individual patient medical records.

20. The machine-readable data migration utility of claim 19, wherein the plurality of individual patient records include fields for at least one of the following types of information: patient identity, day and week information for the administration of at least one of medicine and test results, demographic information, diabetes therapy, and healthcare provider data.

21. The machine-readable data migration utility of claim 18, wherein the method further comprising the step of comparing the medical information in the source database to the medical information in the destination database.

22. The machine-readable data migration utility of claim 21, further comprising the step of determining if any medical information in the source database is substantially identical to any medical information in the destination database.

23. The machine-readable data migration utility of claim 22, further comprising the step of prompting the user to select a method for migrating the substantially identical medical information.
